(19) United States
(12) Patent Application Publication
(10) Pub. No.: US 2008/0171805 A1
(43) Pub. Date: Jul. 17, 2008

(54) Waterproofing product that reduces the spread of fire

(76) Inventor: Diego Mingarelli, Fabriano (AN) (IT)

Correspondence Address: HODES, PESSIN & KATZ, P.A., 901 Dulaney Valley Road, Suite 400, Towson, MD, 21204, US

(21) Appl. No.: 12/006,977

(22) Filed: Jan. 8, 2008

(30) Foreign Application Priority Data
Jan. 17, 2007 (IT) MC2007A000008

(51) Int. Cl. C08K 3/00; C09D 5/18

(52) U.S. Cl. 523/122; 524/2; 524/5

(57) ABSTRACT

This invention concerns a product that waterproofs and reduces the spread of fire. Comprising of at least a first component and a second component. The first component comprising of at least an always flexible elastomer; The second component comprises of at least a cement, where the said waterproofing product comprises also of at least a third component this being flame retardant.

The purpose of this invention is to be a waterproofing product, in this case a so called waterproofing liquid, that reduces the spread of fire.

According to working knowledge, there are different types of waterproofing, not withstanding that none of those in liquid form have fire retardant properties or increase the time taken for the flames to spread.

A waterproofing product must present certain predetermined characteristics; in particular it must:

be applicable to imperfect and irregular surfaces, be elastic within a predetermined range of movements, to behave as a plastic when these predetermined movements become excessive, or alternatively when the said surface is formed with permanent deformation. In all cases the waterproofing product must adapt itself easily to movement of the surface caused by natural temperature changes.

Further more a waterproofing product must be able to bridge small existing cracks, and also those that are formed during the passing of time, caused by changes in temperature and atmosphere.

Since subject to climatic changes a waterproofing product must resist hot temperature, considering that the expansion of the surface is always different to that of a waterproofing product. Further more it must be robust and have little or no sensitivity to wind, hurricane, rain, cold, salty air, remain flexible at low temperatures and therefore not be subject to shattering, it must guarantee a good dimensional stability within a broad range of temperatures and must resist compression from both permanent and accidental loads. A waterproofing product must have a good adhesion to the surface both immediately after application and over the passing of time, it must guarantee a good waterproofing also after the passing of time, must be resistant to sulphur compounds derived from pollution, suns rays and standing water. Must guarantee a reduced application time.

Actually according to the working knowledge different types of waterproofing products exist; for example rolls of waterproofing membranes of an asphalt base. These waterproofing membranes are excessively sensitive to changes in temperature, are very fragile in intensely cold conditions and subject to fast aging and degeneration when not protected from the UV rays. The techno-physical characteristics, the durability and the dependability are derived in the most part from reinforcing material, made from polyester or bitumen card, in this way obtaining a continuous film and being indissoluble from various layers.

An open flame or a source of extreme heat is used during the application, when this material is applied to a wooden surface or any inflammable surface the application can be dangerous because of the fire risk, moreover there is a risk of burning and of personal injury to the operator. After the application the bitumen membrane causes the spread of an open flame at a non desirable speed, this is due to its various components, especially when this material is applied to a wooden surface.

Another type of waterproof covering is PVC, it contains compounds of PVC and fibre glass. The polymer of the laminated PVC offers an excellent resistance to atmospheric changes. Nevertheless a lot of good sense is needed during the application, and a sealant for the overlapping edges. Furthermore in the case of a fire, a notable quantity of carbon monoxide and dioxide is generated.

Another type of waterproof covering is a permanently flexible elastomer that is able to buckle and move together with the manufactured article without coming unstuck. The waterproofing cover is generically referred to as a ‘liquid sheath’ (a cream that when applied hardens and protects the manufactured article from water). This product can be mono component manufactured with, a self curing polyurethane resin, a bitumen based formula. Or it can be bi-component formulated from epoxy resin or polyurethane resin. However these types of waterproofing systems have no fire retarding or inflammable characteristics. In essence all waterproofing systems in a liquid form have no fire retarding or inflammable characteristics. This problem is most felt in countries where by for tradition or for culture the houses and/or buildings are built from wood or for the most part are wooden.

In all the examples of waterproofing systems, it is the waterproofing itself that is flammable or that doesn't have the possibility to be a flame retardant or to increase security, whilst being applied and whilst in use.

The purpose of this invention is to satisfy all the above mentioned problems. acrylic resin, styrene acrylic resin, vinyl resin, styrene butadiene resin

The purpose of this invention is to be a sealant, in this case a waterproofing product, a so called liquid, that reduces the spread of fire made up of at least a first component and a second component. The first component containing at least a permanently flexible elastomer resin, the second component containing at least a cement and also containing a third component, said third component being flame retardant.

Particularly in its preferred form the first component comprises predominantly of a styrene acrylic resin, acrylic resin, vinyl resin, styrene butadiene resin, self curing polyurethane resin, bitumen base resin, and bi-component epoxy resin or polyurethane resin. The second component comprises predominantly of a Portland type cement; or a Blast furnace cement or a calcium aluminium cement. The third component comprises predominantly or entirely of magnesium hydroxide and/or aluminium hydroxide.

The third component is added to and/or mixed to the said first component and/or to said second component.

In essence the waterproofing product, in accordance with this invention the two parts (the first and second components) are kept separate up to the point of mixing after which the hardening process, necessary for the application, immediately starts.

The two parts are made up of the first and second components or rather the resin and the cement to which is added either in combination or alternatively, only to the first or only to the second component or in to both, the third component or rather magnesium hydroxide or aluminium hydroxide.

The primary materials that identify the components of this invention are: styrene acrylic resin, a fire retardant filler (aluminium hydroxide or magnesium hydroxide) possible additives and Portland cement.

According to this invention the waterproofing product unites the function of the styrene acrylic resin with the physical properties of the cement and the advantages derived from the use of the fire retardant filler such as aluminium hydroxide or magnesium hydroxide.

The two principle components or rather resin and cement can also be added to by a plasticization agent in order to improve the performance.

In order to facilitate the mixing and dispersion of the second component (a base cement) in to the first component (resin based) the adding of a mixing agent could be for seen.

The principle advantages that are obtained are; the easy application, the drying speed, resistance to standing water, the elasticity, the application and resistance at both high and low temperatures (at −25° C. the product is still flexible), resistance to UV rays, the easy maintenance, the application by, brush, roller, spray or wiper blade. both on vertical and horizontal planes, reduction in the possibility of human error. Further more the fact that the product could be reinforced with a fibre glass mesh gives it a notable resistance both structural and as a flooring, forming a single, well blended film preventing any water infiltration (without welding). Furthermore this product does not feel the cracks and won't break away with the varying weather conditions or with the settling of the base surface, is more durable over time than the traditional waterproofing products, it is fire resistant and a flame retardant.

The best result can be obtained by inserting a preferred quantity of magnesium hydroxide or aluminium hydroxide into the resin based component or into the cement based component in particularly Portland cement (blast furnace or calcium aluminium cement).

Magnesium hydroxide and aluminium hydroxide both have the power to neutralize the toxic emission created by fire, carbon monoxide and carbon dioxide.

The insertion of a flame retardant into the formula has caused the product to lose some of it physical characteristics required of a waterproofing agent. These characteristics are achieved again by adding a calibrated quantity of additives, in accordance with the quantity described in the following tables. The said first component comprises of an elevated percentage of acrylic styrene resin or acrylic resin responsible for the excellent waterproofing ability, this resin is added to with different substances, such as ANTI-CALCAREOUS that reduces the build up of calcium carbonate (CaCO₃) on the applied film. Also an ANTI-FOAM is added that contributes to the reduction of the build up of bubbles in the thickness of the applied product. (the bubbles could be a weak point both in the water absorption within the film especially when dealing with standing water, and in the fragility if the film subject to stretching). Also a DISPERSING AGENT that facilitates the dispersion of all the solid components of the mixture, therefore generating a more homogeneous product. Also a THICKENING AGENT that allows an easier drawing up of the product during application both horizontal and vertical. Also a PLASTICIZATION AGENT that contributes to the elasticity of the dried film and therefore makes it less fragile. Also a SOLVENT that is slow to evaporate such as an agent that permits the product to be used at low temperatures. Also a WATER REPELLENT that makes the product repel water. Also a ANTI-UV Agent that restores the free radicals that could be formed by the exposure to the suns rays. And finally an ANTI BACTERIA agent in order to avoid the presence of bacteria during the storage. The preferred quantity of the described additives are illustrated in the following table 1

TABLE 1

| First Component | |
|---|---|
| STYREN ACRILIC OR ACRILIC RESIN | 84.7% |
| ANTI CALCIFIER | 0.14% |
| ANTI FOAM AGENT | 0.5% |
| DISPERSING AGENT | 0.5% |
| ALUMINIUM HYDROXIDE (Third Component) | 10% |
| THICKENING AGENT | 0.15% |
| PLASTICIZER AGENT | 0.8% |
| SLOW EVAPORATING SOLVENT | 0.9% |
| WATER REPELLENT AGENT | 1.6% |
| ANTI BACTERIA AGENT | 0.2% |
| ANTI UV AGENT | 1% |
| Formula | 100.49% |
| Total | |

The parameters of the quantities in table 1 are illustrated in Table 2 described bellow:

TABLE 2

| | Range of |
|---|---|
| First Component | Variation |
| Styrene Acrylic Resin or Acrilic Resin or Vinyl Resin or | 50 ÷ 90% |
| Styrene Butadiene Resin or Bitumen Base Formula | |
| Anti Calcifer | 0.1 ÷ 0.2% |
| Anti Foam | 0.5 ÷ 1% |
| Dispersine Agent | 0.5 ÷ 1% |
| Aluminium Hydroxide or Magnesium Hydroxide | 1 ÷ 45% |
| (Third Component)) | |
| Thikning Agent | 0.12 ÷ 0.18% |
| Plastificizing | 0.1 ÷ 1.5% |
| Slow Evaporatine Solvent | 0.5 ÷ 1% |
| Water Repellent Agent | 1 ÷ 2% |
| Anti Bacteria Agent | 0.1 ÷ 0.5% |
| Anti UV Agent | 0.1 ÷ 2% |

The preferred quantities of the second component are described in Table 3 described below:

TABLE 3

| Second | |
|---|---|
| Component | |
| Portland Cement or Blast Furnace Cement or | 90% |
| Calcium Aluminium Cement | |
| Aluminium Hydroxide (Third Component) | 10% |
| Total formula | 100% |

The parameters of the quantities in Table 3 are illustrated in Table 4 described below:

TABLE 4

| Second | Range of |
|---|---|
| Component | Variation |
| Portland Cement or Blast Furnace Cement or | 70.0 ÷ 99.0% |
| Calcium Aluminium Cement | |
| Aluminium or Magnesium Hydroxide (Third Component) | 1 ÷ 30.0% |

The preferred mixing ratio of the first component with the second component is indicated in Table 5 described below:

TABLE 5

| | |
|---|---|
| First Component | 68% |
| Second Component | 32% |
| Product Ready for Application | 100% |

The acceptable variance in the mixture between the first component and the second component is indicated in Table 6, described below:

TABLE 6

| | Range of |
|---|---|
| | Variation |
| First Component | 40% ÷ 99% |
| Second Component | 1% ÷ 60% |

Aluminium Hydroxide contains the necessary properties to be a flame retardant. This substance at a high temperature and exposed to naked flame suffers an endothermic dehydration, or rather releases water that subtracts heat. In this way the system is cooled, the water from the dehydration process, dilutes the gases whilst it evaporates and the mass that is then formed from the dehydration process (Al₂O₃) creates a protective layer on the surface, that slows down the thermal feedback and the exchange of materials.

The formation of black toxic smoke is greatly lessened (black smoke from carbon monoxide CO and carbon dioxide CO₂). The aluminium hydroxide can be substituted with magnesium hydroxide which is also an effective flame retardant.

In accordance with the preferred application process the flame retardant or rather the third component is mixed with either the first or the second component before the first and the second component are mixed together.

The first component, in liquid form, is mixed with second component, a solid substance usually a powder and the following the chemical reaction occurs between the two, the waterproofing hardens in about 2 hours if applied at a temperature of 21° c. however if conserved in the correct conditions it can be applied up to 24 hours after the mixing of the three components.

The styrene acrylic resin is water based and about 50% of dry substance, with a viscosity of 6500±2500 mPas and a pH value of 8.0±0.5, also a marked capacity to be mixed with Portland cement (of blast furnace cement or calcium aluminium cement).

The anti calcareous can be substituted by a different but similar anti calcareous. As can the anti foam be substituted by any other anti foam, containing a non ionic synthetic hydro carbon surface active agent. The dispersing agent can be substituted with others that have a pH value between 8.0 and 9.0 made up of sodium salt and carboxylic acids.

The aluminium hydroxide should be pure, about 99.6% and micronized, or can be otherwise substituted with Magnesium hydroxide.

Any polymer dissolved in water with thickening properties can be used as the thickening agent.

Any plasticizer agent with same active ingredients can be used as the plasticizing agent.

The Hydrophobic Agent can be substituted with any hydrophobic wax emulsion to water base with a pH value between 8.0 and 9.0.

Any Anti Bacteria with the same function can be used as the Anti Bacteria.

Any Anti UV agent with same function can be used as the Anti UV agent.

Any binding hydraulic cement with the same level of resistance can be used instead of Portland, Blast furnace, or Calcium aluminium, cements. The preferred is a Portland limestone cement. During the production phase of said first component, in accordance with this invention, one or more of the following quality controls of the primary materials found in the said first component, are foreseen.

For every lot of resin; the integrity of the seal must be verified, at least one but preferably three samples are taken, preferably 1 kilo of each one, each sample is then conserved for at least six months. For each sample, the colour, and/or the viscous ness, and/or the dryness, and/or the pH value, is checked.

A preferred quantity of this resin is mixed with the Portland cement in order to verify the compatibility.

During the production phase of the said second component, in accordance with this invention, one or more of the following quality controls of the primary materials found in the said second component are foreseen.

The lack of lumps or impurities both in the cement and in the mixture of cement and aluminium hydroxide or magnesium hydroxide is verified, before the packaging.

The following are further phases of quality control during the production of the first component:

The viscosity of the product and/or the pH value are verified after the production process has been finished.

It is verified that the first component can be mixed with a preferred quantity of both the second and of the third component to make a well blended film 0.5 mm thick.

Via the above procedure it is possible to produce a waterproofing product, in accordance with the current invention, of an extremely high quality.

Another purpose of this invention is as a waterproofing system for buildings; roofs, foundations, balconies, basements, (both level and not) pedestrian surfaces, roof flashings, swimming pools, tanks, canals, car parks, or similar that require the use of a waterproofing system in accordance with the present invention.

The waterproofing system is best used in combination with an anti floating fibre glass mesh. This fibre glass mesh can be impregnated with an anti alkaline starch. Furthermore according to the current invention, this waterproofing system can also be used in combination with an elastic bandage for the angles and joints.

This bandage is self adhesive and made with a non cloth material or polyester material.

With the simultaneous application of this elastic bandage with the reinforcement mesh, the robustness of the joints surpasses the tearing force and the vibration caused by the passing of a hurricane, guaranteeing that the surface treated with this waterproofing system will not be damaged.

1. The waterproofing system reduces the spread of flames and comprises of at least a first component and a second component, the said first component comprising of at least an permanently flexible elastomer sealant and the said second component comprising of a cement, is characterized by the fact that the said waterproofing product comprises, of at least a third component the said third component being flame retardant.

2. The waterproofing system in accordance with the previously described claim, is characterized by the fact that the said first component comprises predominantly of a styrene acrylic resin, acrylic resin, vinyl resin, styrene butadiene resin, self curing polyurethane resin, bitumen base resin, and bi-component epoxy resin or polyurethane resin, the said second component comprises predominantly of Portland Cement, calcium aluminium cement, or blast furnace cement and said third component comprises predominantly of Magnesium Hydroxide and Aluminium Hydroxide.

3. According to claim 1 the waterproofing product is characterized by the fact that the said third component is added to and/or mixed with the said first component and/or with the said second component.

4. According to claim 1 the waterproofing product is characterized by the fact that the said third component is preferably aluminium hydroxide.

5. According to claim 1 the waterproofing product is characterized by the fact that the said first component is in liquid form.

6. The waterproofing product is characterized by the fact that the said second component, is in a solid form mainly powder.

7. The waterproofing product is characterized by the fact that the said first component contains a percentage of the said acrylic resin, or styrene acrylic resin or vinyl resin or styrene butadiene resin or a self curing polyurethane resin or bitumen base formula, a percentage that varies between 50% and 90% but is preferably 84.7%.

8. According to claim 1 the waterproofing product is characterized by the fact that the said first component is added to by the said third component containing Magnesium Hydroxide or Aluminium Hydroxide in a ratio of 1% to 45%, 10% Aluminium Hydroxide is preferable.

9. According to claim 1 the waterproofing product is characterized by the fact that the said first component is added to with anti calcareous in a ratio of between 0.1% and 0.2%, preferably 0.14% of the first component.

10. According to claim 1 the waterproofing product is characterized by the fact that the said first component is added to with an anti foam in a ratio of between 0.5% and 1%, preferably 0.5% of the first component.

11. According to claim 1 the waterproofing product is characterized by the fact that the said first component is added to with a dispersion agent in a ratio of 0.55 and 1%, preferably 0.5% of the first component.

12. According to claim 1 the waterproofing product is characterized by the fact that the said first component is added to by a thickening agent in a ratio of between 0.12% and 0.18%, preferably 0.15% of the first component.

13. According to claim 1 the waterproofing product is characterized by the fact that the said first component is added in with a plasticization agent in a ratio of between 0.1% and 1.5%, preferably 0.8% of the first component.

14. According to claim 1 the waterproofing product is characterized by the fact that the said first component is added to with a water repellent in a ratio of between 1% and 2%, preferably 1.6% of the first component.

15. According to claim 1 the waterproofing product is characterized by the fact that the said first component is added to with an Anti UV agent in a ratio of between 0.1% and 2%, preferably 1% of the first component

16. According to claim 1 the waterproofing product is characterized by the fact that the said first component is added to with an Anti Bacteria agent in a ratio of between 0.1% and 0.5%, preferably 0.2% of the first component.

17. According to claim 1 the waterproofing product is characterized by the fact that the said first component is added to with a slow evaporating solvent in a ratio of between 0.5% and 1%, preferably 0.9% of the first component.

18. According to claim 1 the waterproofing product is characterized by the fact that the said second component contains a percentage of the said Portland cement of Aluminium calcium cement or Blast Furnace cement in a ratio of between 70% and 99%, preferably 90% of the second component.

19. According to claim 1 the waterproofing product is characterized by the fact that the said second component is added to by a third component of Magnesium Hydroxide or Aluminium Hydroxide in a ratio of between 1 % and 30%, preferably Aluminium Hydroxide at 10% of the second component.

20. According to claim 1 the waterproofing product is characterized by the fact that the said second component is added to by the first component before the application, in a ratio of between 1% and 60%, preferably 32%.

21. The waterproofing product is characterized by the fact that the said Styrene resin dispenses in water.

22. According to claim 2 the waterproofing product is characterized by the fact that the said Styrene resin is made up of 50% of dry material.

23. According to claim 2 the waterproofing product is characterized by the fact that the said Acrylic styrene resin has a viscosity of 6500±2500 mPas.

24. According to claim 2 the waterproofing product is characterized by the fact that the said first component Acrylic Styrene resin has a pH value of 8.0±0.5.

25. According to claim 2 the waterproofing product is characterized by the fact that the said first component has the ability to mix with the said cement.

26. According to claim 10 the waterproofing product is characterized by the fact that the said Anti foam has a non ionic synthetic hydro carbon surface active agent.

27. According to claim 11 the waterproofing product is characterized by the fact that the said dispersing agent has a pH value of between 8.0 and 9.0 and is preferably made up of sodium salt from carbolic acid.

28. According to claim 2 the waterproofing product is characterized by the fact that the said Magnesium hydroxide and/or aluminium hydroxide is 99.6% pure and is micronized.

29. According to claim 12 the waterproofing product is characterized by the fact that the said thickening agent is a polymer that disperses in water with thickening properties.

30. According to claim 14 the waterproofing product is characterized by the fact that the said water repellent is a wax emulsion with a pH value between 8.0 and 9.0.

31. According to claim 2 the waterproofing product is characterize by the fact that the said Portland cement is a Portland with limestone.

32. According to claim 2 the waterproofing product is characterized by the fact that the said cement reacts with the catalyst.

33. According to claim 1 the waterproofing product is characterized by the fact that the said waterproofing product is applicable up to 24 hours after the mixing of the three components.

34. According to claim 1 made the waterproofing product is characterized by the fact that the said waterproofing product solidifies in about 2 hours after the application at 21° c.

35. Method for the production of a waterproofing product according to claim 1 is characterized by the fact that the following foreseen controls are carried out on the primary materials of the first component for every lot of resin the integrity of the sealing ability is verified, one but preferably three samples, each of 1 kilo, are conserved for at least 6 months and then the colour and/or the viscosity and/or the dryness, and/or the pH value checked, a preferred quantity of the said resin being mixed with the said cement to verify their compatibility.

36. Method for the production of a waterproofing product according to claim 35 characterized by the fact that the following foreseen controls are carried out on the primary materials of the second component: the lack of lumps and/or impurities both in the cement and in the mixture of cement and aluminium hydroxide or magnesium hydroxide is verified before packaging.

37. Method for the production of a waterproofing product according to claim 35 is characterized by the fact that the following quality controls or carried out on the said first component: at the and production the viscosity and/or the pH value is measured, a preferred quantity of the second component is mixed with a preferred quantity of the third component and is spread to form a film 0.5 mm thick.

38-42. (canceled)
